(19) United States
(12) Patent Application Publication
(10) Pub. No.: US 2012/0188648 A1
(43) Pub. Date: Jul. 26, 2012

(54) LENS MODULE AND IMAGE PICK-UP APPARATUS INCORPORATING SAME

(75) Inventors: CHIEN-NAN LAI, Tu-Cheng (TW); SHENG-JUNG YU, Tu-Cheng (TW); HOU-YAO LIN, Tu-Cheng (TW)

(73) Assignee: HON HAI PRECISION INDUSTRY CO., LTD., Tu-Cheng (TW)

(21) Appl. No.: 13/283,609

(22) Filed: Oct. 28, 2011

(30) Foreign Application Priority Data
Jan. 26, 2011 (TW) 100102779

(51) Int. Cl. G02B 7/02

(52) U.S. Cl. 359/614

(57) ABSTRACT

A lens module includes a lens barrel, two lenses, and a light shielding plate. The lens barrel has a light passing hole and a receiving hole in communication with the light passing hole. The lenses are received in the receiving hole and aligned with the light passing hole and aligned with the light passing hole. The light shielding plate is arranged between the two lenses. The conic section of the light shielding plate prevents unwanted or stray light from reaching the image sensor.

### BACKGROUND

1. Technical Field

The present disclosure relates generally to a lens module and an image pick-up apparatus incorporating the lens module.

2. Description of Related Art

Many image pick-up apparatuses are used in a variety of consumer electronic devices, such as notebook computers, personal digital assistants (PDAs), and cellular telephones. There is an increasing demand for better image quality, which essentially depends on the quality of the lens module of the image pick-up apparatus. That is, a lens module with a high image quality is desired.

Referring now to FIG. 6, a lens module 15 used in an image pick-up apparatus includes a light shielding plate 11 and two lenses 151, 152. The two lenses 151 and 152 are aligned with each other, and the light shielding plate 11 is sandwiched between and aligned with the two lenses 151 and 152. The light shielding plate 11 defines a cylindrical through hole 15A at the center thereof for allowing the passage of light, and has an inner side face 150 in the through hole 15A. The light shielding plate 11 is for absorbing light which falls thereon, thereby eliminating the stray light in the lens module 15. In other words, glare in the lens module 15 is eliminated. When the light through the lens module 15 is very strong, the inner side face 150 of the light shielding plate 11 in the through hole 15A cannot completely prevent the stray light, and reflects some of the light onto the image sensor of an image pick-up apparatus incorporating the lens module 15. This will influence the imaging quality of the image pick-up apparatus incorporating the lens module 10.

Therefore, there is a need for a lens module and an image pick-up apparatus, to overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a sectional view of a light shielding plate according to a first exemplary embodiment.

FIG. 2 is a sectional view of a light shielding plate according to a second exemplary embodiment.

FIG. 3 is a sectional view of a light shielding plate according to a third exemplary embodiment.

FIG. 4 is a sectional view of an image pick-up apparatus comprising the light shielding plates of FIGS. 1 and 2, according to a fourth exemplary embodiment.

FIG. 5 is a sectional view of a lens module comprising the light shielding plate of FIG. 3, according to a fifth exemplary embodiment.

FIG. 6 is a sectional view of a related art of a lens module.

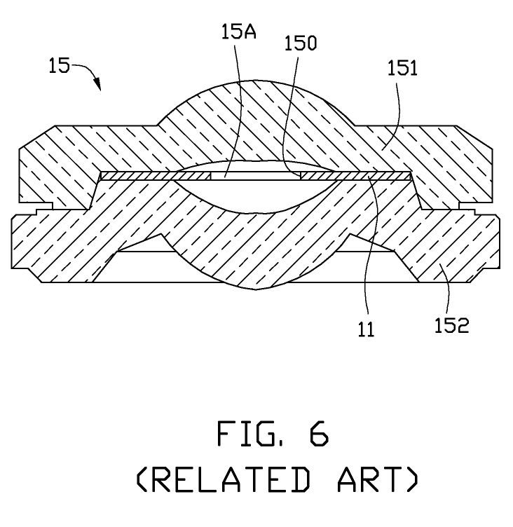

### DETAILED DESCRIPTION

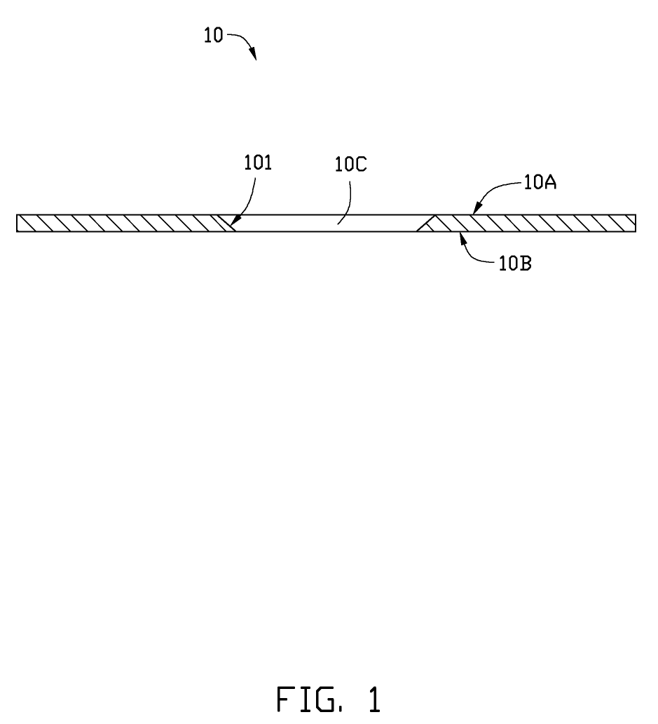

Referring to FIG. 1, a light shielding plate 10 in accordance with a first exemplary embodiment is a round disk. The light shielding plate 10 has a first surface 10A and a second surface 10B facing away from the first surface 10A. The light shielding plate 10 defines a through hole 10C at the center thereof and through the first and second surfaces 10A and 10B. The through hole 10C tapers from the first surface 10A to the second surface 10B, thereby forming a small section of a shallow cone (conical surface 101) in the through hole 10C. The conical surface 101 is interconnected between the first surface 10A and the second surface 10B. In an alternative embodiment, the light shielding plate 10 can also be rectangular. The thickness of the light shielding plate 10 is in the range from about 0.030 mm to about 0.054 mm.

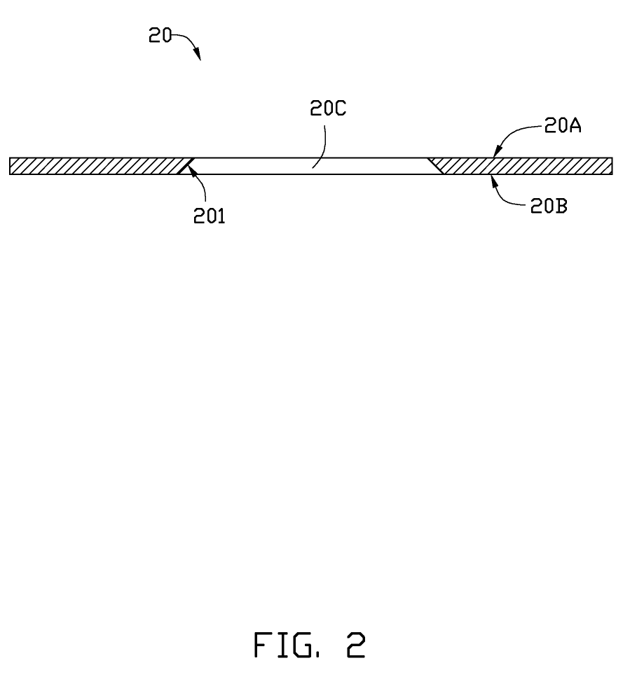

Referring to FIG. 2, a light shielding plate 20 in accordance with a second exemplary embodiment is also a round disk. The light shielding plate 20 has a third surface 20A and a fourth surface 20B facing away from the third surface 20A. The light shielding plate 20 defines a through hole 20C at the center thereof and through the third and fourth surfaces 20A and 20B. The through hole 20C tapers from the fourth surface 20B to the third surface 20A, thereby forming a conical surface 201 in the through hole 20C. The conical surface 201 is interconnected between the third surface 20A and the fourth surface 20B. The light shielding plate 20 has an outer diameter and a thickness greater than those of the light shielding plate 10. In an alternative embodiment, the light shielding plate 20 can also be rectangular.

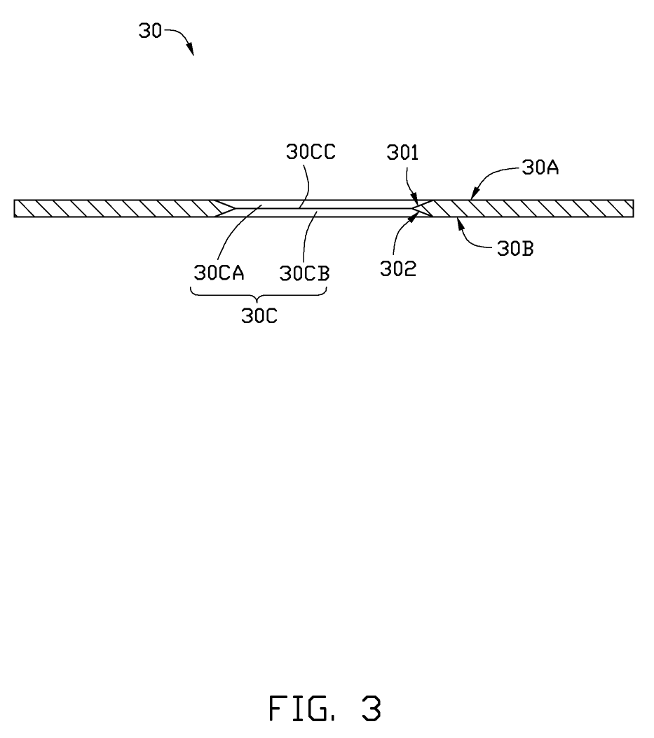

Referring to FIG. 3, a light shielding plate 30 in accordance with a third exemplary embodiment is also a round disk. The light shielding plate 30 has a fifth surface 30A and a sixth surface 30B facing away from the fifth surface 30A. The light shielding plate 30 defines a through hole 30C at the center thereof and through the fifth surface 30A and the sixth surface 30B. The through hole 30C includes a first hole portion 30CA adjacent to the fifth surface 30A, and a second hole portion 30CB adjacent to the sixth surface 30B. The first hole portion 30CA and the second hole portion 30CB are aligned with and in communication with each other, so as to create (in section) an internal knife edge. An imaginary interface 30CC between the first hole portion 30CA and the second hole portion 30CB is formed between the fifth surface 30A and the sixth surface 30B. The first hole portion 30CA tapers from the fifth surface 30A to the interface 30CC, and the second hole portion 30CB tapers from sixth surface 30B to the interface 30CC. Thus, a first conical surface 301 is defined in the first hole portion 30CA, and the second conical surface 302 is defined in the second hole portion 30CB. The first conical surface 301 and the second conical surface 302 intersect at a common line in the interface 30CC.

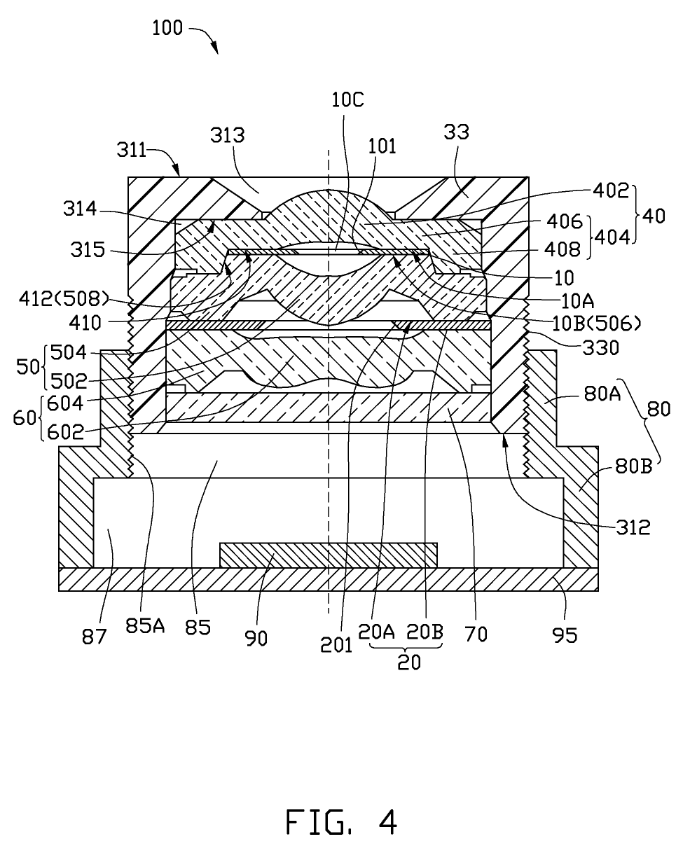

Referring to FIG. 4, an image pick-up apparatus 100 in accordance with a fourth exemplary embodiment includes the light shielding plate 10, the light shielding plate 20, a lens barrel 33, a first lens 40, a second lens 50, a third lens 60, an infrared filter 70, a holder 80, and an image sensor 90. The lens barrel 33 has a first end face 311 and an opposite second end face 312. A light passing hole 313 is defined in the first end face 311, and a receiving hole 314 is defined in the second end face 312. The light passing hole 313 is conical in section and tapers away from the first end face 311. The receiving hole 314 is cylindrical. The light passing hole 313 is in communication with the receiving hole 314, thereby forming an interface 315 between the light passing hole 313 and the receiving hole 314. The light passing hole 313 at the interface 315 has a diameter less than that of the receiving hole 314. Thus, the interface 315 faces toward the receiving hole 314. The light passing hole 313 allows ambient light to enter into the receiving hole 314. The receiving hole 314 receives the light shielding plate 10, the light shielding plate 20, the first lens 40, the second lens 50, the third lens 60, and the Infrared filter 70. The lens barrel 33 has an outer thread 330 on the surface adjacent to the second end face 312.

In this embodiment, the first, second and third lenses 40, 50, and 60 are plastic. The first lens 40 is adjacent to the first end face 311, the third lens 60 is adjacent to the second face 312, and the second lens 50 is between the first lens 40 and the third lens 60. The first, second and third lenses 40, 50, and 60 focus light entering the light passing hole 313 onto the image sensor 90.

The first lens 40 includes a central round portion 402 and a peripheral stepped structure 404. The peripheral stepped structure includes a radially extending portion 406 surrounding the central round portion 402, and an axially extending portion 408 extending axially from the radially extending portion 406 toward the second lens 50. The peripheral stepped structure 404 has an inward-facing surface 410 and a conical side face 412. The inward-facing surface 410 belongs to the radially extending portion 406, and is adjacent to the central round portion 402. The conical side face 412 belongs to the axially extending portion 408, and is adjacent to the inward-facing surface 410. The conical side face 412 is inclined in a direction away from the central round portion 402.

The second lens 50 includes a central round portion 502 and a peripheral portion 504 surrounding the second central round portion 502. The peripheral portion 504 has an outward-facing surface 506 adjacent to the second central round portion 502, and a conical side face 508 adjacent to the outward-facing surface 506. The conical side face 508 extends inwards from the out-facing surface 506, and is inclined in a direction away from the second central round portion 502. The inclined angle between the outward-facing surface 506 and the conical side face 508 is the same as that between the inward-facing surface 410 and the conical side face 412.

The third lens 60 includes a central round portion 602 and a peripheral portion 604 surrounding the second central round portion 602. The Infrared filter 70 filters IR light at this point.

The first lens 40, the second lens 50, the third lens 60 and the Infrared filter 70 are received in the receiving hole 314 from the first end face 311 to the second end face 312 in the order described. The second lens 50 engages with the first lens 40 in such a way that the conical side face 508 contacts the conical side face 412, and the inward-facing surface 410 faces and is parallel with the outward-facing surface 506. The light shielding plate 10 is arranged between the inward-facing surface 410 and the outward-facing surface 506 in such a manner that the first surface 10A contacts the inward-facing surface 410 and the second surface 10B contacts the outward-facing surface 506. The through hole 10C is aligned with the central round portions 402 and 502. The second light shielding plate 20 is arranged between the second lens 50 and the third lens 60 in such a manner that the peripheral portion 504 is in contact with the third surface 20A and the peripheral portion 604 is in contact with the fourth surface 20B. The Infrared filter 70 is in contact with the peripheral portion 604 of the third lens 60.

The holder 80 includes a cylindrical connection portion 80A and a receiving portion 80B. The connection portion 80A defines a cylindrical through hole 85 and an interior thread 85A in the through hole 85. The interior thread 85A is in threaded engagement with the outer thread 330. The receiving portion 80B extends axially from the end of the connection portion 80A away from the lens barrel 33. The receiving portion 80B defines a through hole 87 in communication with the through hole 85. The image pick-up apparatus 100 further includes a printed circuit board 95 fixed to the end of the receiving portion 80B away from the connection portion 80A and capping the through hole 87.

The image sensor 90 can be a charge-coupled device (CCD) or a complementary metal-oxide-semiconductor (CMOS). The image sensor 90 is arranged on and electrically connected with the printed circuit board 95. The image sensor 90 is received in the through hole 87, and faces the Infrared filter 70. The image sensor 90 is optically coupled with the first lens 40, the second lens 50, the third lens 60 and the Infrared filter 70.

In this embodiment, because the conical surface 101 is inclined toward the first end face 311, the conical surface 101 can reflect some of the light entering the light passing hole 313 away from the image sensor. Furthermore, the conical surface 201 is inclined away from the first end face 311, thus any light which does not fall directly through the light passing hole 313 can reach the conical surface 201. Thus, any glare in the image pick-up apparatus 10 is effectively reduced.

In alternative embodiments, the locations of the light shielding plates 10 and 20 can be exchanged. The number of the lenses in the image pick-up apparatus 100 may vary.

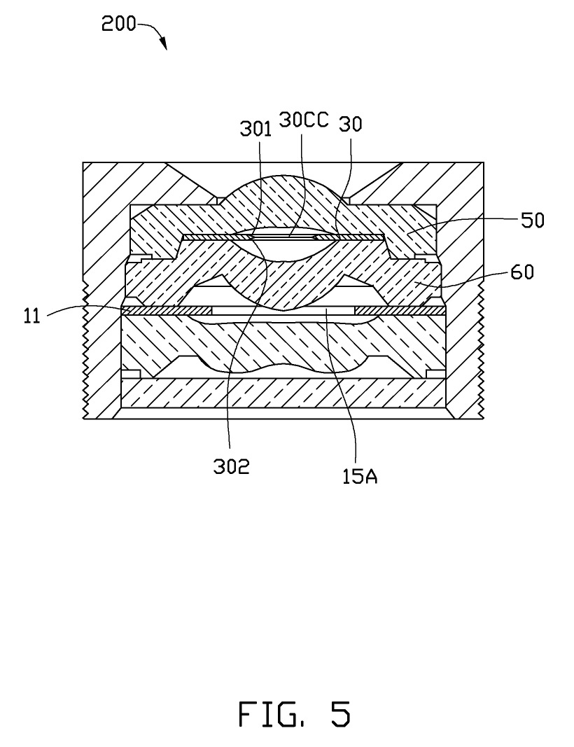

Referring to FIG. 5, an image pick-up apparatus 200 in accordance with a fifth exemplary embodiment is similar to the image pick-up apparatus 100 of the fourth exemplary embodiment. The distinguishing features are that the light shielding plate 30 is between the second lens 50 and the third lens 60, instead of the square-edged light shielding plate 11. The through hole 15A of the light shielding plate 11 has a diameter greater than that of the interface 30CC of the light shielding plate 30. The first conical surface 301 of the light shielding plate 30 has the same function as that of the conical surface 101 in the image pick-up apparatus 100, and the second conical surface 302 of the light shielding plate 30 has the same function as that of the conical surface 201 in the image pick-up apparatus 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A lens module, comprising:
a lens barrel having a light passing hole and a receiving hole in communication with the light passing hole;
a first lens and a second lens received in the receiving hole and aligned with the light passing hole, the first lens being adjacent to the light passing hole; and
a first light shielding plate arranged between the first and second lenses, the first light shielding plate having a first surface adjacent to the first lens and a second surface facing away from the first surface, the first light shielding plate defining a first through hole through the first and second surfaces, the first through hole being optically aligned with the first and second lenses, the first light shielding plate having a first conical inner surface between the first surface and the second surface in the first through hole.

2. The lens module of claim 1, wherein the first conical inner surface is interconnected between the first surface and the second surface, and faces toward the second surface.

3. The lens module of claim 1, wherein the first conical surface is interconnected between the first surface and the second surface, and faces toward the first surface.

4. The lens module of claim 1, wherein the first light shielding plate further comprises a second conical inner surface between the first surface and the second surface, the first conical inner surface connected to the second conical inner surface, the second conical inner surface facing away from the first conical inner surface.

5. The lens module of claim 2, further comprising a third lens arranged in the receiving hole on an opposite side of the second lens to the first lens, and a second light shielding plate between the second lens and the third lens, the second light shielding plate having a third surface and an opposite fourth surface, the third surface adjacent to the second lens, and the fourth surface adjacent to the fourth lens, the second light shielding plate defining a second through hole interconnected between the third surface and the fourth surface, the second through hole optically aligned with the third lens, and being conical and tapering from the fourth surface to the third surface.

6. An image pick-up apparatus, comprising:
a lens barrel having a light passing hole and a receiving hole in communication with the light passing hole;
a first lens and a second lens received in the receiving hole and aligned with the light passing hole, the first lens being adjacent to the light passing hole;
a first light shielding plate arranged between the first and second lenses, the first light shielding plate having a first surface adjacent to the first lens and a second surface facing away from the first surface, the first light shielding plate defining a first through hole through the first and second surfaces, the first through hole being optically aligned with the first and second lenses, the first light shielding plate having a first conical inner surface between the first surface and the second surface in the first through hole; and
an image sensor optically aligned with the first and second lenses.

7. The image pick-up apparatus of claim 6, wherein the first conical inner surface is interconnected between the first surface and the second surface, and faces toward the second surface.

8. The image pick-up apparatus of claim 6, wherein the first conical inner surface is interconnected between the first surface and the second surface, faces toward the first surface.

9. The image pick-up apparatus of claim 6, wherein the first light shielding plate further comprises a second conical inner surface between the first surface and the second surface, the first conical inner surface connected to the second conical inner surface, the second conical inner surface facing away from the first surface.

10. The image pick-up apparatus of claim 7, further comprising a third lens arranged in the receiving hole on an opposite side of the second lens to the first lens, and a second light shielding plate between the second lens and the third lens, the second light shielding plate having a third surface and an opposite fourth surface, the third surface adjacent to the second lens, and the fourth surface adjacent to the fourth lens, the second light shielding plate defining a second through hole interconnected between the third surface and the fourth surface, the second through hole optically aligned with the third lens, and being conical and tapering from the fourth surface to the third surface.
